(19) United States
(12) Patent Application Publication
(10) Pub. No.: US 2014/0026869 A1
(43) Pub. Date: Jan. 30, 2014

(54) FUEL DELIVERY SYSTEM INCLUDING A HEAT PIPE ASSEMBLY

(71) Applicants: Shiguang Zhou, Ann Arbor, MI (US); Thomas A. McCarthy, Dearborn, MI (US); Furqan Zafar Shaikh, Troy, MI (US); Carlos Armesto, Canton, MI (US); Syed K. Ali, Dearborn, MI (US); Lawrence Marshall, Saint Clair Shores, MI (US); Peter Kanefsky, West Bloomfield, MI (US); Michael Levin, Ann Arbor, MI (US); Danrich Henry Demitroff, Okemos, MI (US); Scott Donald Cooper, Ann Arbor, MI (US)

(72) Inventors: Shiguang Zhou, Ann Arbor, MI (US); Thomas A. McCarthy, Dearborn, MI (US); Furqan Zafar Shaikh, Troy, MI (US); Carlos Armesto, Canton, MI (US); Syed K. Ali, Dearborn, MI (US); Lawrence Marshall, Saint Clair Shores, MI (US); Peter Kanefsky, West Bloomfield, MI (US); Michael Levin, Ann Arbor, MI (US); Danrich Henry Demitroff, Okemos, MI (US); Scott Donald Cooper, Ann Arbor, MI (US)

(73) Assignee: FORD GLOBAL TECHNOLOGIES, LLC, Dearborn, MI (US)

(21) Appl. No.: 13/560,738

(22) Filed: Jul. 27, 2012

(51) Int. Cl. F02M 31/20; F02M 33/00

(52) U.S. Cl. 123/541; 123/514

(57) ABSTRACT

A fuel delivery system is provided herein. The fuel delivery system may include a fuel tank storing a liquid fuel, a return fuel line including an outlet opening into the fuel tank, and a heat pipe assembly including a first end positioned in a surrounding atmosphere, and a second end positioned at and coupled to the return fuel line.

### BACKGROUND/SUMMARY

Fuel stored in a fuel tank and fuel delivery system may be exposed to high temperatures during engine operation. As a result, the temperature of the fuel in the fuel delivery system, and in particular the fuel tank, may exceed a threshold temperature. The excessive temperature condition may degrade the fuel tank and other components (e.g., a fuel pump) in the fuel delivery system. Furthermore, the over-temperature fuel delivered to the engine by the fuel system to downstream components may also reach undesirable temperatures, which may decrease combustion efficiency.

Attempts have been made to reduce the temperature of the fuel delivery system via the engine cooling system. For example, coolant may be redirected from an engine cooling circuit to various portion of the fuel delivery system to provide cooling. However, certain components in the fuel delivery system may require a greater level of cooling than the engine cooling circuit can provide. For example, the temperature of the coolant in some engine cooling circuits may not fall below 100° C. However, the desired temperature of certain components in the fuel delivery system, the fuel in the fuel delivery system, etc., may be below 70° C.

Other attempts have been made to reduce the temperature of the fuel delivery system via an air cooler. The air cooler may be packaged in the front of vehicle or in an area where there is a desired amount of air flow. However, damage to the air cooler from a collision is a concern in these locations.

Attempts have also been made to further reduce the temperature of various components in the fuel delivery system, such as a fuel injector, by other heat transfer mechanisms. U.S. Pat. No. 3,945,353 discloses a fuel injection nozzle having a heat pipe coupled thereto. The heat pipe removes heat from the nozzle and therefore reduces the temperature of the fuel traveling through the nozzle. In this way, fuel traveling through the injector may be cooled.

However, the Inventors have also recognized several drawbacks with the system disclosed in U.S. Pat. No. 3,945,353. To achieve a desired amount of cooling, the condenser of the heat pipe may need to be positioned in a section of the engine or vehicle having a low temperature. However, these low temperature regions may not be close to the fuel injector. Therefore, to reach the low temperature region, the length of the heat pipe is increased. Lengthening the heat pipe may have deleterious effects on the heat pipe's functionality and efficiency, as well as increase the cost of the heat pipe. Moreover, the fuel upstream of the fuel injector may reach undesirable temperatures. This may be particularly problematic in plastic fuel tanks which are more susceptible to thermal degradation than metal fuel tanks. The thermal loading may be exacerbated during periods of engine operation when the ambient temperature surrounding the engine is high. Furthermore, packaging constraints in the fuel injector may limit the size of the heat pipe, thereby limiting the amount of heat that may be removed by the heat pipe.

As such, in one approach a fuel delivery system is provided. The fuel delivery system includes a fuel tank storing a liquid fuel, a return fuel line including an outlet opening into the fuel tank, and a heat pipe assembly including a first end positioned in a surrounding atmosphere, and a second end positioned at and coupled to the return fuel line. In some examples, the heat pipe assembly and specifically the first end may be positioned external (e.g., below) the vehicle frame. In this way, the airflow around the first end may be increased during vehicle travel thereby increasing the cooling provided to the return fuel line.

The heat pipe may be positioned in a more protected zone in the vehicle, for example spaced away from the vehicle body with one or more crush zones between the body and the heat pipe. Such a position may be less susceptible to damage during a collision than the front end of the vehicle, thereby reducing the likelihood of heat pipe damage. Furthermore, the heat pipe and specifically the condenser may also be positioned in a location in the vehicle with a desired amount of airflow, increasing the amount of heat that may be removed from the return fuel line via the heat pipe. Further in some examples, the working fluid of the heat pipe may be water, which may provide desired heat transfer characteristics for petroleum fuel.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of an internal combustion engine;

FIG. 2 shows a schematic illustration of a vehicle including the engine shown in FIG. 1, a fuel delivery system, and a heat pipe assembly;

FIGS. 3 and 4 show different views of an example heat pipe assembly;

FIGS. 5 and 6 show additional embodiments of the heat pipe assembly;

FIG. 7 shows a cross-sectional view of an example heat pipe assembly; and

FIG. 8 shows a method for operation of a heat pipe assembly.

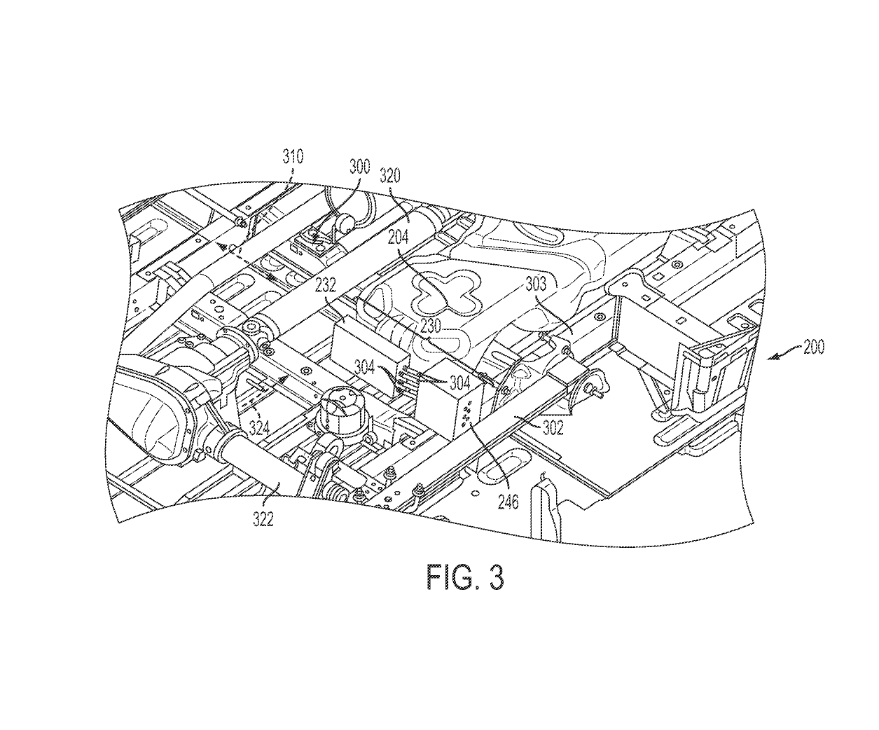

FIGS. 3-6 are drawn approximately to scale.

### DETAILED DESCRIPTION

A fuel delivery system is provided herein. The fuel delivery system may include a fuel tank storing a liquid fuel, a return fuel line including an outlet opening into the fuel tank, and a heat pipe assembly including a condenser section dissipating heat from a condenser end of a sealed pipe to the surrounding environment and an evaporator section receiving heat from the return fuel line and transferring heat to an evaporator end of the fluidly sealed pipe.

In this way, the heat pipe assembly may be used to passively remove heat from the return fuel line, thereby reducing the temperature of the fuel returned to the fuel tank. As a result, the temperature of the fuel tank may be reduced to a desirable level. Moreover, lower cost materials may be used to construct the fuel tank, such as plastic if desired, when the temperature of the fuel is reduced.

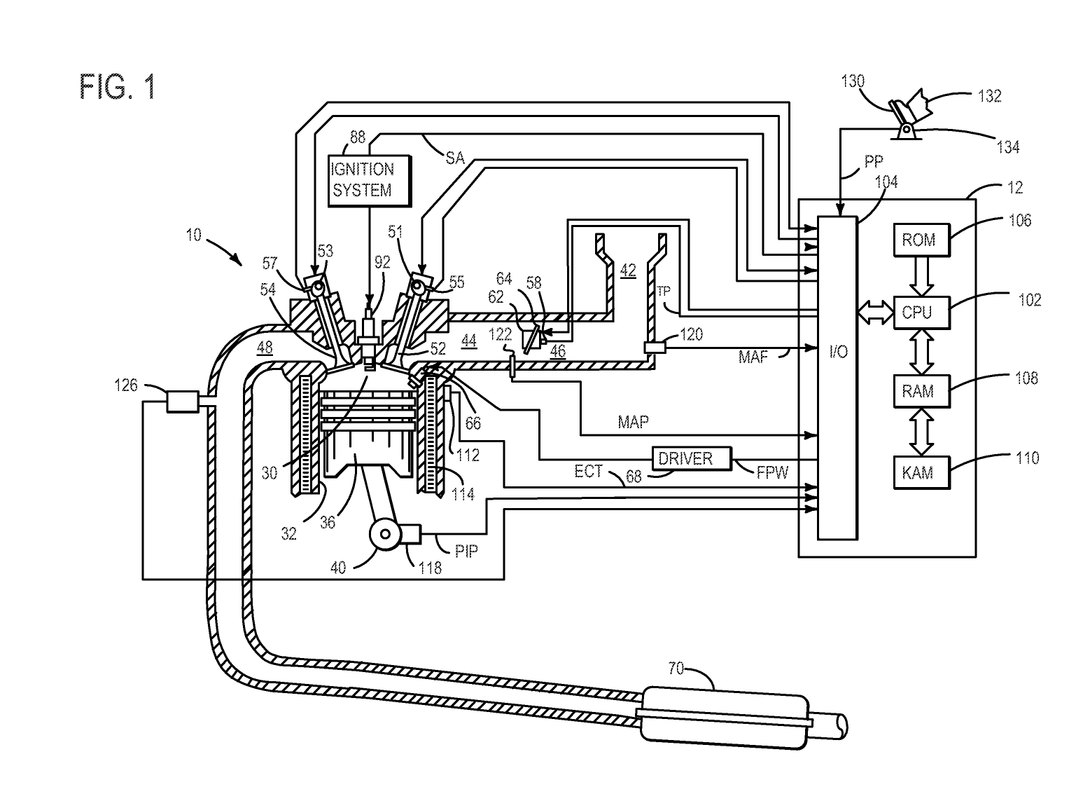

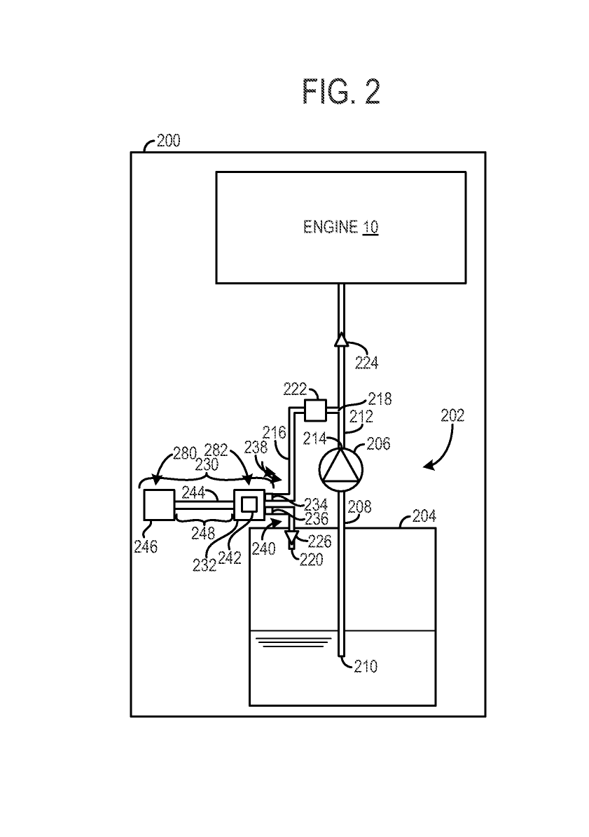

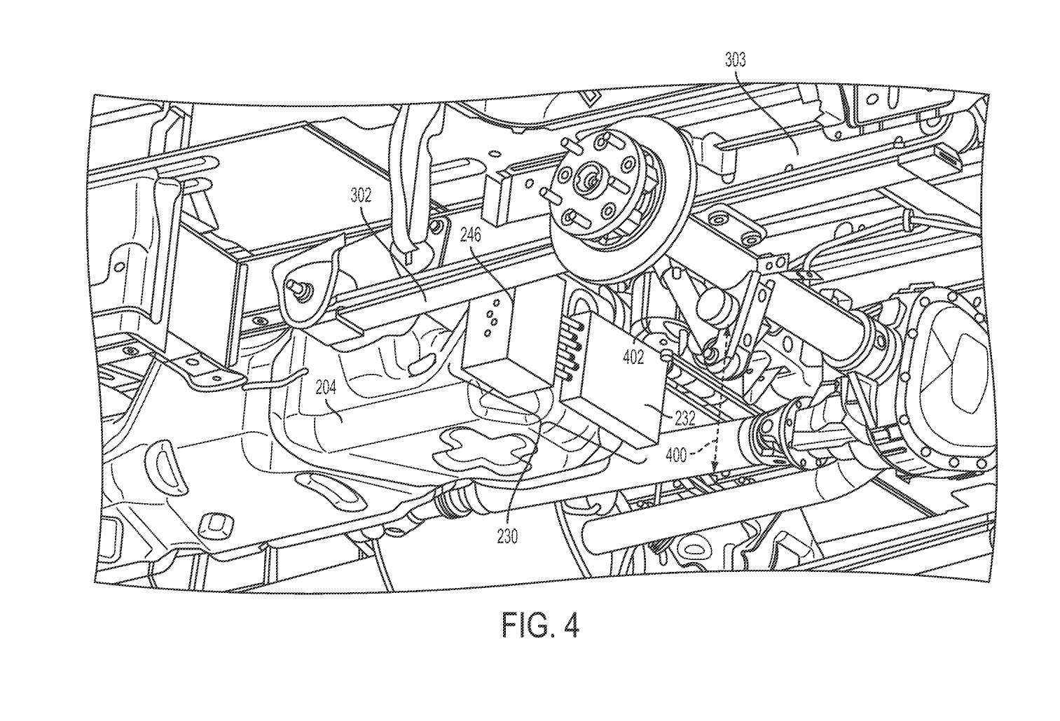

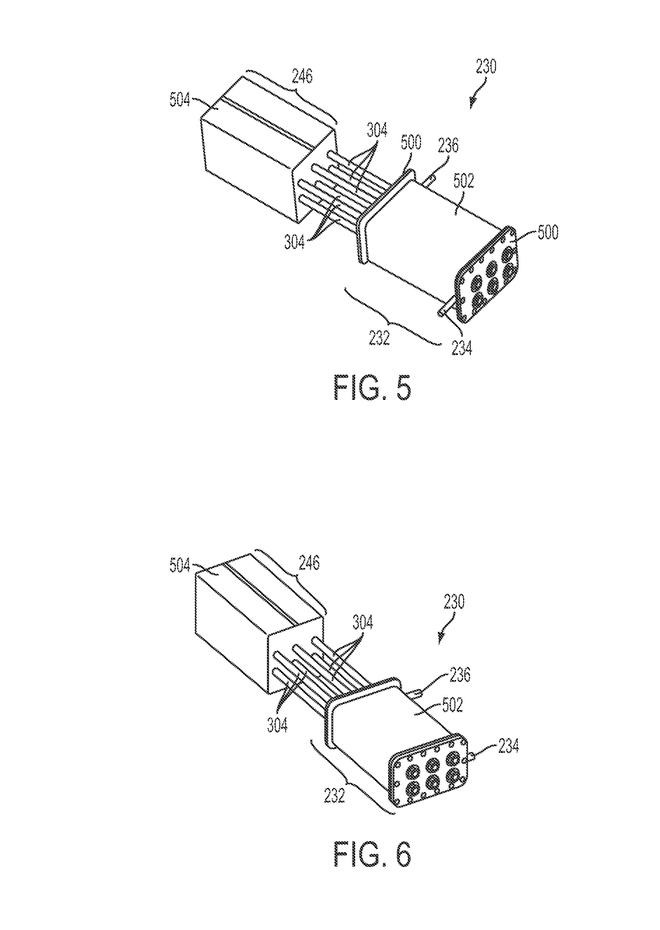

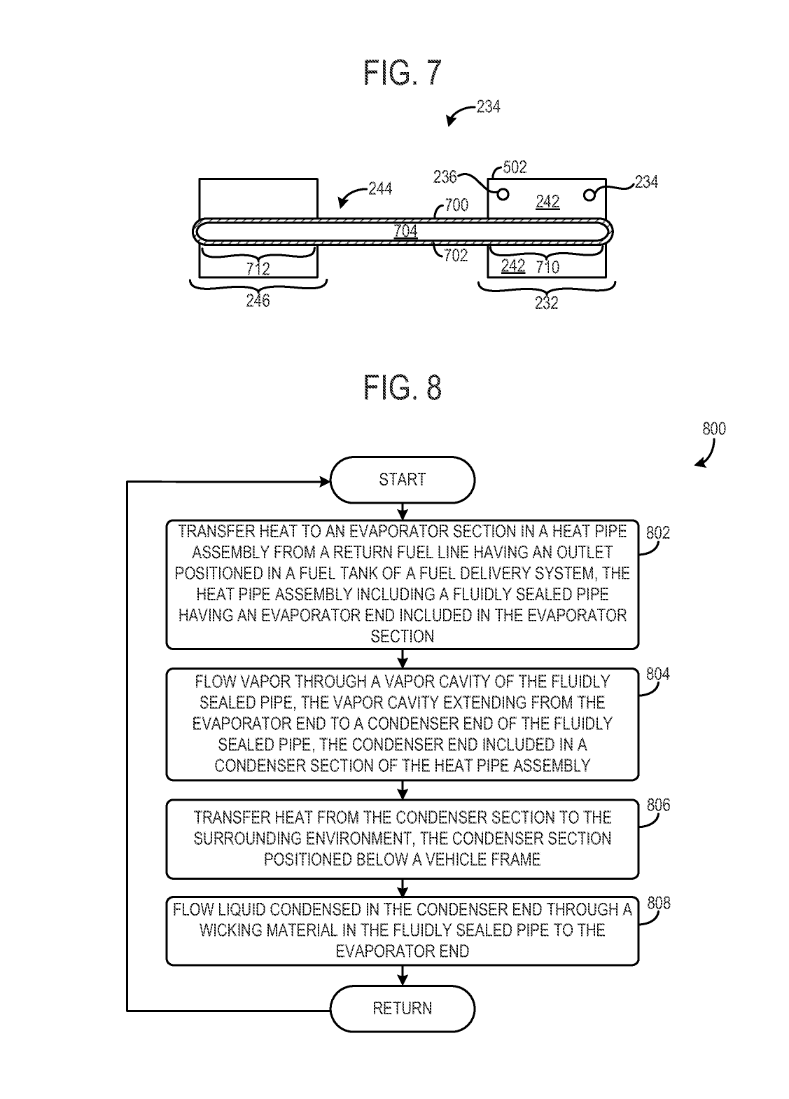

FIG. 1 shows a schematic depiction of an internal combustion engine. FIG. 2 shows a schematic depiction of a vehicle including the engine, a fuel delivery system, and a heat pipe assembly. FIGS. 3-4 show different views of an example heat pipe assembly coupled to an example vehicle. FIGS. 5-6 show additional embodiments of the heat pipe assembly. FIG. 7 shows a cross-sectional view of a heat pipe assembly. FIG. 8 shows a method for operation of a heat pipe assembly.

Referring to FIG. 1, internal combustion engine 10, comprising a plurality of cylinders, one cylinder of which is shown in FIG. 1, is controlled by electronic engine controller 12. Engine 10 includes combustion chamber 30 and cylinder walls 32 with piston 36 positioned therein and connected to a crankshaft 40. Combustion chamber 30 is shown communicating with intake manifold 44 and exhaust manifold 48 via respective intake valve assembly 52 and exhaust valve assembly 54. Each intake and exhaust valve assembly may be operated by an intake cam 51 and an exhaust cam 53. Alternatively or additionally, one or more of the intake and exhaust valves may be operated by an electromechanically controlled valve coil and armature assembly. The position of intake cam 51 may be determined by intake cam sensor 55. The position of exhaust cam 53 may be determined by exhaust cam sensor 57.

Fuel injector 66 is shown positioned to inject fuel directly into cylinder 30, which is known to those skilled in the art as direct injection. Additionally or alternatively, fuel may be injected to an intake port, which is known to those skilled in the art as port injection. Fuel injector 66 delivers liquid fuel in proportion to the pulse width of signal FPW from controller 12. Fuel is delivered to fuel injector 66 by a fuel delivery including a fuel tank, fuel pump, and fuel rail (not shown). Fuel injector 66 is supplied operating current from driver 68 which responds to controller 12. In addition, intake manifold 44 is shown communicating with optional electronic throttle 62 which adjusts a position of throttle plate 64 to control air flow from intake boost chamber 46. In other examples, the engine 10 may include a turbocharger having a compressor positioned in the induction system and a turbine positioned in the exhaust system. The turbine may be coupled to the compressor via a shaft. A high pressure, dual stage, fuel delivery system may be used to generate higher fuel pressures at injectors 66.

Distributorless ignition system 88 provides an ignition spark to combustion chamber 30 via spark plug 92 in response to controller 12. However, in other examples the ignition system 88 may not be included in the engine 10 and compression ignition may be utilized. Universal Exhaust Gas Oxygen (UEGO) sensor 126 is shown coupled to exhaust manifold 48 upstream of catalytic converter 70. Alternatively, a two-state exhaust gas oxygen sensor may be substituted for UEGO sensor 126.

Converter 70 can include multiple catalyst bricks, in one example. In another example, multiple emission control devices, each with multiple bricks, can be used. Converter 70 can be a three-way type catalyst in one example.

Controller 12 is shown in FIG. 1 as a conventional microcomputer including: microprocessor unit 102, input/output ports 104, read-only memory 106, random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to an accelerator pedal 130 for sensing accelerator position adjusted by foot 132; a knock sensor for determining ignition of end gases (not shown); a measurement of engine manifold pressure (MAP) from pressure sensor 122 coupled to intake manifold 44; an engine position sensor from a Hall effect sensor 118 sensing crankshaft 40 position; a measurement of air mass entering the engine from sensor 120 (e.g., a hot wire air flow meter); and a measurement of throttle position from sensor 58. Barometric pressure may also be sensed (sensor not shown) for processing by controller 12. In a preferred aspect of the present description, engine position sensor 118 produces a predetermined number of equally spaced pulses every revolution of the crankshaft from which engine speed (RPM) can be determined.

In some examples, the engine may be coupled to an electric motor/battery system in a hybrid vehicle. The hybrid vehicle may have a parallel configuration, series configuration, or variation or combinations thereof. Further, in some examples, other engine configurations may be employed, for example a diesel engine.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC). During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion. Additionally or alternatively compression may be used to ignite the air/fuel mixture. During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is described merely as an example, and that intake and exhaust valve opening and/or closing timings may vary, such as to provide positive or negative valve overlap, late intake valve closing, or various other examples.

FIG. 2 shows a schematic depiction of a vehicle 200 including engine 10. A fuel delivery system 202 is also included in the vehicle 200. The fuel delivery system 202 is configured to provide fuel to the combustion chamber 30 at desired time intervals. The fuel delivery system 202 includes a fuel tank 204. The fuel tank may house a suitable fuel such as diesel, gasoline, bio-diesel, an alcohol based fuel (e.g., ethanol, methanol), etc. Specifically, in one embodiment the fuel tank 204 houses a diesel fuel and the engine 10 is configured to perform compression ignition. Therefore, the ignition system 88, shown in FIG. 1, may be omitted from the engine 10 in such an embodiment. Furthermore, the fuel tank 204 may comprise a polymeric material, in some embodiments. In other embodiments, the fuel tank 204 may comprise a metal material.

The fuel delivery system 202 further includes a pump 206 having a pick-up tube 208 including an inlet 210 positioned in the fuel tank 204. The pump 206 is positioned external to the fuel tank 204, in the depicted embodiment. However, other pump locations have been contemplated.

The fuel delivery system 202 further includes a supply fuel line 212 in fluidic communication with an outlet 214 of the pump 206 and various components in the engine 10. For example, the supply fuel line 212 may be configured to provide fuel to a fuel rail and fuel injectors (e.g., port and/or direct injectors). Arrow 224 denotes the flow of fuel from the pump 206 to the engine 10.

A return fuel line 216 is also included in the fuel delivery system 202. The return fuel line 216 includes an inlet 218 in fluidic communication with the supply fuel line 212 and an outlet 220 in fluidic communication with the fuel tank 204. Thus, the return fuel line 216 extends into the fuel tanks and the outlet 220 is enclosed by the housing of the fuel tank 204. Arrow 226 denotes the general direction of fuel flow through the return fuel line 212. A valve 222 may be positioned in the return fuel line 216. The valve 222 may be configured to allow fuel to pass therethrough when the fuel pressure in the return fuel line 216 is above a predetermined pressure. In this way, the fuel pressure of the fuel in the fuel delivery system 202 may be regulated. The valve 222 may be a passively operation valve such as a check valve or an actively controlled valve such as a solenoid valve controllable via controller 12, shown in FIG. 1.

It will be appreciated that the fuel delivery system 202 may include additional components that are not depicted, if desired. For example, a number of valves for regulating the fuel pressure may be included in the fuel delivery system. Moreover, a second pump may also be included in the fuel delivery system 202.

A heat pipe assembly 230 is also shown in FIG. 2. The heat pipe assembly 230 includes an evaporator section 232. Heat may be transferred from fuel in the return fuel line 216 to the evaporator section 232. The evaporator section 232 includes a fuel inlet 234 and a fuel outlet 236. As shown, the fuel inlet 234 is in fluidic communication with an upstream section 238 of the return fuel line 216 and the fuel outlet 236 is in fluidic communication with a downstream section 240 of the return fuel line 216. The heat pipe assembly may be coupled to the return fuel line 216.

A fuel passage denoted generically, via box 242, is in fluidic communication with the fuel inlet 234 and the fuel outlet 236. The fuel passage 242 flows fuel around at least one fluidly sealed pipe 244. Thus, the fuel passage 242 may at least partially surround a portion of the fluidly sealed pipe 244. The fluidly sealed pipe may be referred to as a fluidly sealed heat pipe or a heat pipe. In this way, heat may be transferred from the fuel to the fluidly sealed pipe 244. Additionally, the fluidly sealed pipe 244 includes an evaporator end, discussed in greater detail herein, at least partially enclosed by the fuel passage 242.

The heat pipe assembly 230 also includes a condenser section 246. The condenser section 246 is configured transfer heat from the heat pipe assembly to the surrounding environment. The condenser section 246 is spaced away from the evaporator section 232. The condenser section 246 is included in a first end 280 of the heat pipe assembly 230. Likewise, the evaporator section 232 is included in a second end 282 of the heat pipe assembly 230. The first end 280 may be positioned in a surrounding atmosphere. In this way, heat may be transferred from the end to the surrounding environment. The second end 282 is positioned at and coupled to the return fuel line 216. The fluidly sealed pipe 244 extends between the condenser section 246 and the evaporator section 232. Specifically, the fluidly sealed pipe 244 further includes an intermediary section 248. The intermediary section 248 extends between the evaporator section 232 of the heat pipe assembly 230 and a condenser section 246 of the heat pipe assembly.

The condenser section 246 and the evaporator section 232 are shown in FIG. 2 as being at the same vertical height. However, other relative positions of the condenser section 246 and the evaporator section have been contemplated. For example, the condenser section 246 may be positioned vertically below if wick is used or vertically above the evaporator section 232. Furthermore, a single sealed pipe is depicted in FIG. 2. However, the heat pipe assembly may have additional sealed pipes in other embodiments. In some embodiments, the return fuel line 216 is not cooled via an engine cooling system.

FIG. 3 shows an example vehicle 200. Specifically, the under-side 300 (e.g., under-carriage) of the vehicle 200 is illustrated. The heat pipe assembly 230 is depicted. The fuel tank 204 is also depicted. The evaporator section 232 may be coupled to the return fuel line 216, shown in FIG. 2. However, other positions of the evaporator section 232 have been contemplated. For example the evaporator section 232 may be coupled to a housing of the fuel tank 204. As discussed above with regard to FIG. 2 the evaporator section 232 may have fuel flowing therethrough from the return fuel line 216.

Continuing with FIG. 3, the condenser section 246 is spaced away from the evaporator section 232. Specifically, the condenser section 246 is positioned adjacent to a leaf spring 302 near a rear side of the vehicle 200. The leaf spring 302 is coupled to a rear tire as well as a vehicle frame 303. Additionally, the evaporator section 232 is positioned adjacent to a rear side of the fuel tank 204, in relation to the rear side of the vehicle. The condenser section 246 extends in a lateral direction away from the fuel tank 204. A lateral axis 310 is provided for reference. The heat pipe assembly 230 is positioned between a drive shaft 320 and the leaf spring 302. It has been unexpectedly found that when the heat pipe assembly is positioned in this location the amount of heat removed from the return line via the heat pipe assembly due to the airflow characteristic in this location is increased. As a result, the temperature of the fuel in the fuel tank is reduced. Furthermore, the heat pipe assembly 230 is positioned in front of a final drive unit 322. The final drive unit 322 and the drive shaft 320 may be included in a drive train and coupled to the engine 10, shown in FIGS. 1 and 2, through a transmission. Arrow 324 shows a forward direction. Therefore, a rear direction extends the opposite way. The heat pipe assembly 230 depicted in FIG. 3 includes a plurality of fluidly sealed pipes 304 extending between the condenser section 246 and the evaporator section 232. The fluidly sealed pipes 304 are shown positioned such that a plane extends through the centerline of each of the heat pipes. Therefore, the sealed pipes 304 are aligned in parallel and spaced away from one another. When the heat pipes are positioned in this manner the amount of heat removed via the heat pipes may be increased when compared to heat pipes arranged in multiple planes. In other embodiments, at least two of the fluidly sealed pipes 304 may have different diameters.

FIG. 4 shows another view of the embodiment of the vehicle 200 and heat pipe assembly 230 shown in FIG. 3. As shown, the condenser section 246 is at the same horizontal level with the evaporator section 232. However, other relative positions of the condenser section 246 and the evaporator section 232 have been contemplated. For example, the condenser section may be positioned vertically above or below the evaporator section.

Moreover, the heat pipe assembly 230, and specifically the condenser section 246, is positioned below the vehicle frame 303 and the leaf spring 302. In some examples, the heat pipe and specifically the condenser section may be positioned above the vehicle ground line. A vertical axis 400 is provided for reference. It will be appreciated that the heat pipe assembly 230 may receive a greater amount of airflow during vehicle travel when positioned below the vehicle frame. As a result, the amount of heat removed from the fuel via the heat pipe assembly 230 may be increased when compared to heat pipes that are positioned vertically above the vehicle frame. Additionally, the evaporator section 232 is positioned adjacent to a fuel filter 402.

FIG. 5 shows a second embodiment of the heat pipe assembly 230. The condenser section 246 and the evaporator section 232 shown coupled to one another via a plurality of fluidly sealed pipes 304. As shown, the evaporator section 232 includes the fuel inlet 234 and the fuel outlet 236. As shown, the fuel inlet 234 and the fuel outlet 236 are positioned on opposing sides of the evaporator section 232. The evaporator section 232 is further depicted as including mounting plates 500. The mounting plates may be configured to receive the fluidly sealed pipes 304. Specifically, the fluidly sealed pipes 304 extend through openings in the mounting plates 500. In this way, the mounting plates 500 may fix the relative positioned if the fluidly sealed pipes 304 and support the fluidly sealed pipes.

The evaporator section 232 includes an evaporator housing 502. The evaporator housing 502 may define the boundary of the fuel passage 242, shown in FIG. 2. In this way, fuel may be circulated around the fluidly sealed pipes 304 enabling heat to be transferred from the fuel to the fluidly sealed pipes. It has been found that the heat pipe assembly 230 may cool the fuel in the return fuel line by 45° C. when the ambient temperature is 45° C.

The condenser section 246 includes a condenser casing 504. The condenser casing may include material extending between and surrounding at least a portion of the plurality of fluidly sealed pipes 304. Specifically, in the depicted example the condenser casing 504 is in direct contact with the plurality of fluidly sealed pipes 304. However, other condenser casing configurations have been contemplated. Heat fins may be coupled to the condenser casing 504 and/or the evaporator housing 502 to increase the heat removed from the heat pipe assembly 230. The heat fins may comprise metal such as aluminum. Additionally, the evaporator section 232 and/or the condenser section 246 may comprise plastic and/or a metal such as copper, aluminum, and/or steel (e.g., stainless steel). Furthermore, the fluidly sealed pipes 304 have cross-sections forming a grid pattern.

FIG. 6 shows a third embodiment of the heat pipe assembly 230. As shown, the fuel inlet 234 and the fuel outlet 236 are positioned on the same side of the evaporator section 232. It will be appreciated that the heat pipe assembly 230 shown in FIG. 6 may be used to conform to the contours of the return fuel line.

FIG. 7 shows a depiction of a cross-section of another embodiment of the heat pipe assembly 230. As shown, the heat pipe assembly 230 includes a single fluidly sealed pipe 244. However, as previously discussed the heat pipe assembly may include a plurality of fluidly sealed pipes. As shown, the fluidly sealed pipe 244 includes a housing 700 enclosing a wicking material 702. The wicking material 702 may include a wire mash of steel and/or aluminum. As shown the wicking material 702 traverses the interior periphery of the housing 700. Liquid may flow through the wicking material. Specifically, liquid condensed in the condenser end may be flowed through the wicking material to the evaporator end. However, in other embodiments the wicking material may be omitted from the heat pipe when the condenser end is positioned vertically above the evaporator end.

Additionally, the wicking material 702 encloses a vapor cavity 704. The vapor cavity 704 extends down the fluidly sealed pipe 244 enabling vapor to flow from one section of the fluidly sealed pipe to another. Vapor may flow through the vapor cavity from the evaporator end to the condenser end.

The fluidly sealed pipe 244 includes an evaporator end 710 and a condenser end 712. The evaporator end 710 is partially enclosed via the evaporator housing 502. The condenser end 712 is partially enclosed via the condenser casing. Therefore, the fluidly sealed pipe 244 extends into the evaporator section 232 and into the condenser section 246.

The evaporator section 232 includes the evaporator housing 502 defining the boundary of fuel passage 242. The fuel passage 242 partially surrounds the evaporator end 710. The fuel inlet 234 and the fuel outlet 236 of the fuel passage 242 are also shown. In this way, fuel may be flowed around the fluidly sealed pipe 244. As previously discussed the fuel inlet 234 and the fuel outlet 236 are in fluidic communication with the return fuel line 216. Furthermore, the working fluid in the fluidly sealed pipe may include at least one of water, alcohol, and sodium. In some embodiment, the working fluid may include just water. Water may provide the desired heat transfer properties for cooling of petroleum fuel.

FIG. 8 shows a method for operation of a heat pipe assembly in a fuel delivery system of an engine. The method 800 may be implemented via the system and components described above with regard to FIGS. 1-7 or may be implemented by other suitable systems and components.

At 802 the method includes, transferring heat to an evaporator section in a heat pipe assembly from a return fuel line having an outlet positioned in a fuel tank of a fuel delivery system, the heat pipe assembly including a fluidly sealed pipe having an evaporator end included in the evaporator section. At 804 the method includes flowing vapor through a vapor cavity of the fluidly sealed pipe, the vapor cavity extending from the evaporator end to a condenser end of the fluidly sealed pipe, the condenser end included in a condenser section of the heat pipe assembly. At 806 the method includes transferring heat from the condenser section to the surrounding environment, the condenser section positioned below a vehicle frame. At 808 the method includes flowing liquid condensed in the condenser end through a wicking material in the fluidly sealed pipe to the evaporator end. Therefore, when a wicking material is used in the heat pipe the evaporator end may be positioned vertically above the condenser end. However, in other embodiments, the wicking material may be omitted from the heat pipe and the condenser end may be positioned vertically above the evaporator end. Therefore, the method may include flowing condensed fluid from the condenser end to the evaporator end via gravity at 808, in some embodiments. In this way, heat may be removed from the return fuel line via a passively operated heat pipe assembly. After 808 the method returns to 802 or ends in other embodiments. Additionally, the heat pipe may not be coupled to a controller. In this way, the heat pipe can be passively operated without the use of a controller, if desired. Method 800 may be implemented during engine operation when fuel is flowing through the return fuel line.

This concludes the description. The reading of it by those skilled in the art would bring to mind many alterations and modifications without departing from the spirit and the scope of the description. For example, single cylinder, inline engines, V-engines, and horizontally opposed engines operating in natural gas, gasoline, diesel, or alternative fuel configurations could use the present description to advantage.

1. A fuel delivery system comprising:
a fuel tank storing a liquid fuel;
a return fuel line including an outlet opening into the fuel tank; and
a heat pipe assembly including a first end positioned in a surrounding atmosphere, and a second end positioned at and coupled to the return fuel line.

2. The fuel delivery system of claim 1 wherein the first end includes a condenser section transferring heat from a condenser end of a fluidly sealed pipe in the heat pipe assembly to the surrounding environment and the second end includes an evaporator section receiving heat from the return fuel line and transferring heat to an evaporator end of the fluidly sealed pipe.

3. The fuel delivery system of claim 2, where the fluidly sealed pipe extends between the condenser section and the evaporator section and includes a wicking material at least partially traversing an interior periphery of a housing of the fluidly sealed pipe.

4. The fuel delivery system of claim 2, where the evaporator section includes a fuel inlet and a fuel outlet in fluidic communication with a fuel passage at least partially surrounding the evaporator end, the fuel inlet in fluidic communication with an upstream section of the return fuel line and the fuel outlet in fluidic communication with a downstream section of the return fuel line.

5. The fuel delivery system of claim 4, where the fuel inlet and fuel outlet are positioned on opposing sides of the evaporator section.

6. The fuel delivery system of claim 4, where the evaporator section includes a housing defining the boundary of the fuel passage.

7. The fuel delivery system of claim 2, where the condenser section is positioned below a vehicle frame.

8. The fuel delivery system of claim 6, where the condenser section is positioned adjacent to a leaf spring.

9. The fuel delivery system of claim 2, where the fuel tank comprises a polymeric material.

10. The fuel delivery system of claim 9, where a housing of the condenser section comprises metal.

11. The fuel delivery system of claim 1, where the working fluid in the fluidly sealed pipe comprises water.

12. The fuel delivery system of claim 1, where the fuel tank houses a diesel fuel.

13. The fuel delivery system of claim 1, where the heat pipe assembly is passively operated and not coupled with a controller.

14. The fuel delivery system of claim 1, where the evaporator section is positioned adjacent to a fuel filter and a rear side of the fuel tank.

15. A fuel delivery system comprising:
a fuel tank storing diesel fuel;
a return fuel line including an outlet opening into the fuel tank and an inlet in fluidic communication with a fuel pump; and
a heat pipe assembly including a condenser section positioned vertically below a vehicle frame and transferring heat from condenser ends of a plurality of fluidly sealed pipes included in the heat pipe assembly to the surrounding environment, and an evaporator section receiving heat from the return fuel line and transfer heat to evaporator ends of the plurality of fluidly sealed pipes, each of the fluidly sealed pipes including a vapor cavity enclosed by a wicking material and a housing.

16. The fuel delivery system of claim 15, where at least two of the plurality of fluidly sealed pipes have different diameters, and wherein the plurality of fluidly sealed pipes are aligned in parallel and spaced away from one another.

17. The fuel delivery system of claim 15, where the condenser section is positioned vertically below the evaporator.

18. The fuel delivery system of claim 15, where the condenser section includes a housing having heat fins.

19. A method for operation of a heat pipe assembly in a fuel delivery system of an engine comprising:
transferring heat to an evaporator section in a heat pipe assembly from a return fuel line having an outlet positioned in a fuel tank of a fuel delivery system, the heat pipe assembly including a fluidly sealed pipe having an evaporator end included in the evaporator section;
flowing vapor through a vapor cavity of the fluidly sealed pipe, the vapor cavity extending from the evaporator end to a condenser end of the fluidly sealed pipe, the condenser end included in a condenser section of the heat pipe assembly; and
transferring heat from the condenser section to a surrounding environment, the condenser section positioned below a vehicle frame.

20. The method of claim 19, further comprising flowing liquid condensed in the condenser end through a wicking material in the fluidly sealed pipe to the evaporator end.

21. The method of claim 19, where the evaporator section is positioned vertically below the condenser section.
